(19) United States
(12) Patent Application Publication
(10) Pub. No.: US 2020/0302287 A1
(43) Pub. Date: Sep. 24, 2020

(54) INFORMATION PROCESSING METHOD AND APPARATUS

(71) Applicant: Toshiba Memory Corporation, Minato-ku (JP)

(72) Inventor: Fumihiko TACHIBANA, Yokohama (JP)

(73) Assignee: Toshiba Memory Corporation, Minato-ku (JP)

(21) Appl. No.: 16/565,810

(22) Filed: Sep. 10, 2019

(30) Foreign Application Priority Data
Mar. 18, 2019 (JP) 2019-049615

(51) Int. Cl. G06N 3/08; G06K 9/62; G06N 3/04

(52) U.S. Cl. CPC G06N 3/08; G06N 3/04; G06K 9/6262; G06K 9/6256

(57) ABSTRACT

According to one embodiment, an information processing method for a neural network model optimized by a training by using a processor and a memory includes: outputting a first information processing result by the neural network model using first input data; and outputting a second information processing result by the neural network model using second input data obtained by applying a perturbation to the first input data. The method further includes determining a reliability of the neural network model using the first input data based on a comparison result between the first information processing result and the second information processing result.

### CROSS-REFERENCE TO RELATED APPLICATIONS

This application is based upon and claims the benefit of priority from the Japanese Patent Application No. 2019-049615, filed Mar. 18, 2019, the entire contents of which are incorporated herein by reference.

### FIELD

Embodiments described herein relate generally to an information processing method and an information processing apparatus.

### BACKGROUND

A convolutional neural network (CNN) is a type of deep neural network (DNN) effective for, e.g., image recognition processing.

In deep learning, a CNN model adapted to image recognition processing is generated through a learning processing using a large amount of image data as learning data (or training data). A CNN model is applied to an image recognition system that performs a processing of recognizing (classifying) of unknown images.

An image recognition system applying a CNN model has an event in which an input image is misrecognized (misclassified) due to a type of noise called “perturbation” being applied to the input image. This event may become a problem. In particular, the problem is an event in which the image recognition system misrecognizes an input image due to adversarial attacks against a CNN model. The adversarial attacks, for example, intentionally input data including a noise called “adversarial example”, “adversarial perturbation”, “adversarial image”, etc., into the image recognition system as input data.

### BRIEF DESCRIPTION OF THE DRAWINGS

FIG. 1 is a block diagram illustrating a configuration of a system according to one embodiment;

FIG. 2 is a diagram illustrating functions of a processor including a CNN model in the system according to one embodiment;

FIG. 3 is a flowchart illustrating a processing sequence of the processor in the system according to one embodiment;

FIG. 4 is a diagram illustrating one example of effects of the system according to one embodiment; and

FIG. 5 is a diagram illustrating another example of effects of the system according to one embodiment.

### DETAILED DESCRIPTION

According to one embodiment, an information processing method for a neural network model optimized by a training by using a processor and a memory for use in computation of the processor includes: outputting a first information processing result by the neural network model using first input data; and outputting a second information processing result by the neural network model using second input data obtained by applying a perturbation to the first input data. The method further includes determining a reliability of the neural network model using the first input data based on a comparison result between the first information processing result and the second information processing result.

Various embodiments will be described hereinafter with reference to the accompanying drawings.

### [Configuration of System]

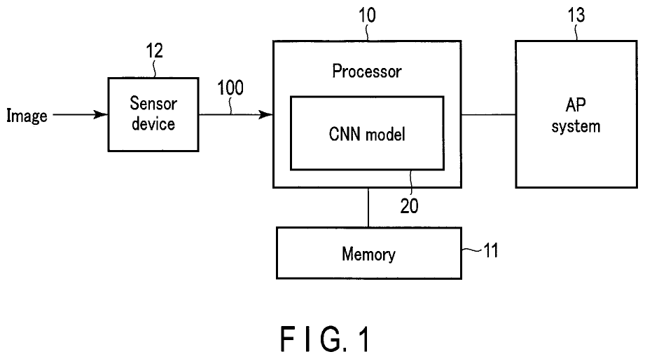

FIG. 1 is a block diagram illustrating a configuration of a system according to a present embodiment. As shown in FIG. 1, the system includes a processor 10, a memory 11, a sensor device 12, and an application (AP) system 13.

In the present embodiment, the processor 10 is, for example, a graphic processing unit (GPU) or a central processing unit (CPU), and is constituted by hardware and software. The processor 10 performs image recognition (classification) processing with respect to image data 100 from the sensor device 12, using a convolutional neural network (CNN) model 20 optimized by a learning processing.

Furthermore, the processor 10 according to the present embodiment realizes a function of making a judgment that an event caused by adversarial examples (hereinafter, occasionally referred to as “AdE”) has occurred in the CNN model 20, by using the memory 11 as described later.

Herein, AdE indicates image data (input image) to be input into the CNN model 20, to which a type of noise called “perturbation” is applied. AdE further indicates adversarial attacks which may cause an event where, for example, the input image is misrecognized (misclassified). AdE is also called “adversarial perturbation” or “adversarial image”.

According to the present embodiment, a vulnerability of the CNN model 20 optimized by a training (adversarial training) to the aforementioned AdE may be improved. In other words, the present embodiment realizes a structure that may improve a robustness of the CNN model 20 against the aforementioned AdE.

The sensor device 12 outputs to the processor 10, image data 100 obtained by scanning, e.g., an image on a sheet basis. The AP system 13 is an image recognition system that recognizes an unknown image input from, for example, the sensor device 12, using an image recognition result by the CNN model 20 performed by the processor 10. The image recognition system includes a computer, a server system, or a cloud system performing Web services, which are constituted by hardware and software.

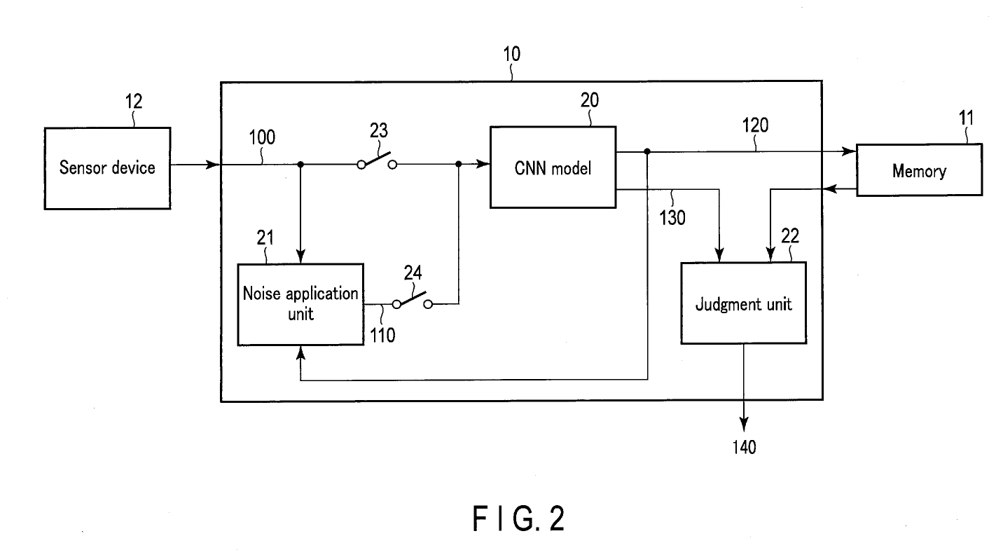

FIG. 2 is a conceptual diagram illustrating functions of the processor 10 that performs the CNN model 20 against AdE. As shown in FIG. 2, the processor 10 includes a noise application unit 21, a judgment unit 22, a first switch unit 23, and a second switch unit 24, as a software function.

The noise application unit 21 applies a perturbation to the image data 100 from the sensor device 12. The judgment unit 22 judges an occurrence of an event of misrecognition in the CNN model 20 due to AdE. The first switch unit 23 switches whether or not to input the image data 100 into the CNN model 20. The second switch unit 24 switches whether or not to input image data 110 to which a noise has been applied by the noise application unit 21, into the CNN model 20.

The noise application unit 21 applies a perturbation calculated by a predetermined calculation method to the image data 100 from the sensor device 12, and outputs the image data 110 to which the perturbation has been applied. Herein, a “perturbation” indicates a noise having a visually-imperceptible regularity, not a random noise. Hereinafter, a perturbation may be simply referred to as a noise.

The noise application unit 21 calculates a noise using a calculation result of an object label included in an output 120 from the CNN model 20, by a predetermined calculation method. Herein, the CNN model 20 performs recognition processing with respect to input value X relating to the input image data 100, and calculates output value Y as a result of the recognition processing included in the output 120. The output value Y represents a probability calculated by using, for example, a softmax function, with respect to candidates of a label to which the input value X belongs.

The output value Y is a value that is normalized in a manner such that the maximum value is equal to 1, the minimum value is equal to 0, and the total of labels is equal to 1. The output value Y corresponds to a reliability degree or a score with respect to each label. As the object label, a correct label may be selected. The correct label is a label whose probability is the highest among the output 120 and which is recognized as correct. For example, in a case where the input image data 100 represents an image similar to a panda, a label of a panda which indicates the highest probability as the output value Y is selected as a correct label.

The noise application unit 21 inputs the calculation result of the object label included in the output 120 from the CNN model 20. On the other hand, the noise application unit 21 inputs the image data 100 from the sensor device 12, and performs a processing similar to the recognition processing by the CNN model 20. Specifically, the noise application unit 21 compares, for example, a recognition result of the image data 100 with the input calculation result of the object label, thereby calculating a loss indicative of a difference as a result of the comparison.

The loss corresponds to an error that is propagated reversely by a back propagation during the learning processing of the CNN model 20. By propagating the loss using a function corresponding to the back propagation function of the CNN model 20, the noise application unit 21 can judge which pixel of an input image (image data 100) is to move and in which direction this pixel is to move in order to decrease or increase the probability of a label to which the input image belongs.

The noise application unit 21 calculates a noise based on the loss to decrease the probability of the object label with respect to the input image data 100 in the CNN model 20, and generates an image data 110 obtained by applying the noise to the input image data 100. Accordingly, in the CNN model 20, when performing the recognition processing with respect to the image data 110 to which the noise has been applied, for example, if the input image data 100 represents an image similar to a panda, the probability that a label indicative of a panda is a correct label decreases, and the possibility that the input image data 100 is misrecognized as another object increases.

### [Operation of System]

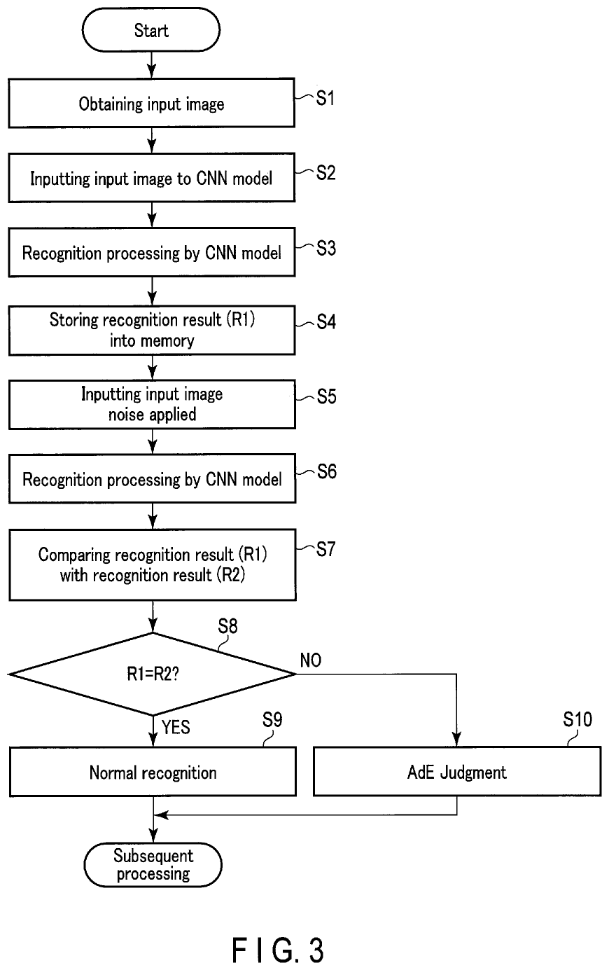

Next, with reference to FIG. 2 and FIG. 3, operations of the system according to the present embodiment will be described. FIG. 3 is a flowchart illustrating a processing sequence of the processor 10. In the present embodiment, the CNN model 20 is a model optimized by a training (adversarial training) against AdE. Specifically, the training against AdE uses input value X2 corresponding to an image data 110 to which a noise has been applied. The noise is calculated by the noise application unit 21 such that degree of increase of loss is relatively high. The training in the present embodiment differs from a learning processing using an input image to which the noise is not applied as learning data (learning processing for generating an optimized CNN model).

As shown in FIG. 3, the processor 10 obtains an input image (image data 100) from the sensor device 12 (51). Herein, as shown in FIG. 2, the processor 10 turns on the first switch unit 23 and turns off the second switch unit 24, thereby inputting the image data 100 corresponding to an original input image, as the input value X1 into the CNN model 20 (S2).

The processor 10 performs the recognition processing to the image data 100 by using the CNN model 20 (S3). The processor 10 stores a recognition result (R1) included in the output 120 from the CNN model 20, into the memory 11 (S4).

Next, the processor 10 turns off the first switch unit 23 and turns on the second switch unit 24, thereby inputting the input image (image data 110) obtained by applying a noise to an original input image, as the input value X2 into the CNN model 20 (S5). That is, as shown in FIG. 2, the processor 10 applies via the noise application unit 21, a noise to the image data 100 as an input image from the sensor device 12, and inputs the image data 110 to which the noise is applied, as the input value X2 into the CNN model 20.

Herein, as shown in FIG. 2, the processor 10 inputs the output 120 of the CNN model 20 into the noise application unit 21. The noise application unit 21 calculates the aforementioned loss using the calculation result of the object label included in the output 120, thereby calculating a noise that makes the degree of increase in the loss relatively low.

Referring back to FIG. 3, by using the CNN model 20, the processor 10 performs the recognition processing with respect to the image data 110 to which a noise has been applied (S6). The processor 10 obtains a recognition result (R2) included in an output 130 from the CNN model 20 with respect to the image data 110, and inputs the recognition result (R2) into the judgment unit 22. The processor 10 inputs the recognition result (R1) from the memory 11 and inputs it into the judgment unit 22.

The processor 10 compares via the judgment unit 22, the recognition result (R1) with the recognition result (R2) (S7). Based on a comparison result 140 by the judgment unit 22, if both the recognition results (R1, R2) are the same (“YES” in S8), the processor 10 judges that the CNN model 20 has made a normal recognition (S9).

On the other hand, based on the comparison result 140 by the judgment unit 22, if the recognition results (R1, R2) are different from each other (“NO” in S8), the processor 10 judges that an event of misrecognition due to AdE in the CNN model 20 has occurred (S10). That is, the processor 10 judges that the CNN model 20 has a low reliability of recognition processing.

As described above, according to the method of the present embodiment, the CNN model 20 optimized by a training against AdE can be judged in terms of its reliability or vulnerability against AdE. That is, the CNN model 20 can secure some degree of tolerance to AdE by a training.

Accordingly, the method of the present embodiment compares the recognition result (R1) of an input image, obtained by the CNN model 20 performing the recognition processing without making any change to the input image, with the recognition result (R2) of the input image to which a noise is applied by the noise application unit 21. If the comparison result shows that both the recognition results (R1, R2) are the same, it is judged that the CNN model 20 makes normal recognition and has high reliability. In other words, it is judged that the CNN model 20 is improved in its vulnerability against AdE by a training.

On the other hand, if a comparison result shows that the recognition results (R1, R2) are different from each other, it is judged that the CNN model 20 has vulnerability against AdE and has low reliability even if trained. Therefore, according to the method of the present embodiment, if a comparison result shows that the CNN model 20 has the vulnerability against AdE and has the low reliability, it is possible to indicate stoppage of operation of the CNN model 20 and performance of another training. As a result, this realizes a structure that can improve the vulnerability of the CNN model against AdE. In other words, it is possible to realize a structure that can improve the robustness of the CNN model against the aforementioned AdE. Described above is the case in which the present embodiment is applied to the CNN model; however, the present embodiment is not limited to this case and is applicable to other neural network models of DNN.

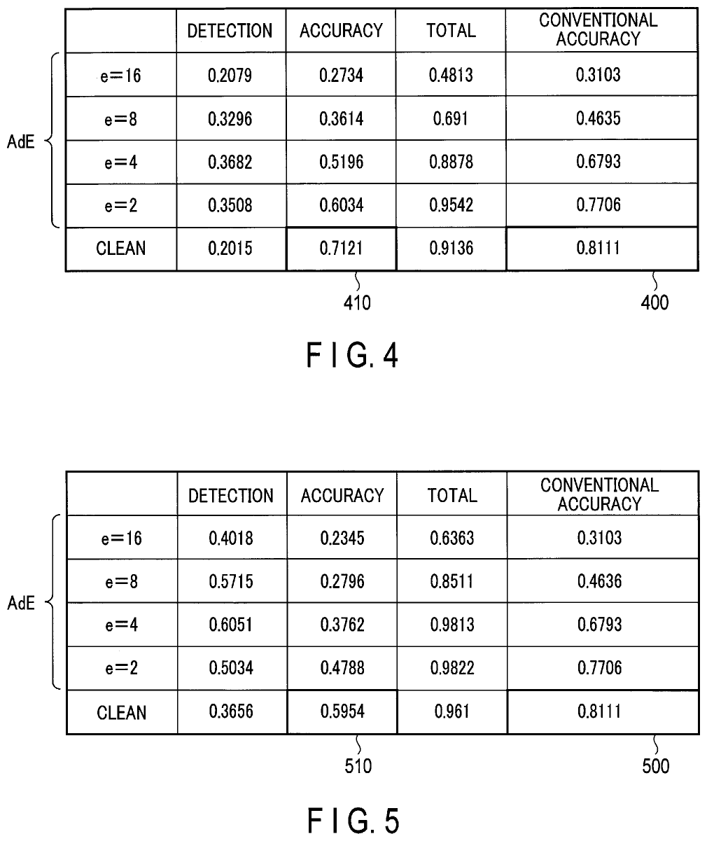

FIGS. 4 and 5 are diagrams illustrating one example of effects of the method and the system according to the present embodiment. In both the cases shown in FIGS. 4 and 5, the CNN model 20 as an object is optimized by a training against AdE of a relatively-high degree (e=8, as an example of a degree of noise). A training is made by repeatedly performing the learning processing of 20 epochs by using, for example, CIFAR10 (image data set prepared for common use as a training sample). Herein, “e” represents a degree of noise, specifically, a value indicating a limiting value of an absolute value of noise amount for calculation units. For example, “e=8” indicates a state where an absolute value of noise amount for a calculation unit is limited to lower than or equal to 8. Herein, the image data has a range of values, for example, “0 to 255”.

FIG. 4 illustrates, as an example, a result of the recognition processing performed in the CNN model 20 after a training, by applying a noise (for example, e=2) that is calculated in a manner such that, as AdE, the degree of an increase of loss is relatively low. For example, in a case where a noise (e=2) calculated by the noise application unit 21 is applied to the image data 100, the recognition result includes a recognition result by the judgment unit 22 with respect to the image data 110 after the noise is applied thereto. This case shows “0.3508” as the recognition rate (DETECTION) that the judgment unit 22 shows the same recognition results, “0.6034” as the recognition accuracy (ACCURACY) with respect to an input image, and “0.9542” as the total (TOTAL) of the recognition rate and the recognition accuracy. Herein, in the CNN model 20, a result of recognition processing with respect to a clean input image unaffected by AdE shows that a conventional recognition accuracy (CONVENTIONAL ACCURACY) 400 is “0.8111” whereas the recognition accuracy (ACCURACY) 410 is decreased to “0.7121”. FIG. 4 further illustrates, as an example, a result of the recognition processing using a noise (for example, e=4, 8, 16) calculated in a manner such that, as AdE, the degree of increase in loss is higher than the noise (e=2). For example, in a case where a noise (e=4) calculated by the noise application unit 21 is applied to the image data 100, a result of the recognition processing with respect to the image data 110 after the application of the noise shows that the recognition accuracy (ACCURACY) and the total (TOTAL) other than the accuracy rate (DETECTION) are decreased in value as compared to the case where the noise (e=2) is applied.

FIG. 5 illustrates, as an example, a result of the recognition processing performed in the trained CNN model 20, by applying a noise (for example, e=4) calculated in a manner such that, as AdE, the degree of increase in loss is relatively low. This case shows “0.6051” as the recognition rate (DETECTION) that the judgment unit 22 shows the same recognition results, “0.3762” as the recognition accuracy (ACCURACY) with respect to an input image, and “0.9813” as the total (TOTAL) of the recognition rate and the recognition accuracy. Herein, in the CNN model 20, a result of recognition processing with respect to a clean input image unaffected by AdE shows that a conventional recognition accuracy (CONVENTIONAL ACCURACY) 500 is “0.8111” whereas the recognition accuracy (ACCURACY) 510 is decreased to “0.5954”. FIG. 5 also illustrates, as an example, a result of the recognition processing using a noise (for example, e=8, 16) calculated in a manner such that, as AdE, the degree of increase in loss is higher than the noise (e=4). For example, in a case where the noise (e=8) calculated by the noise application unit 21 is applied to the image data 100, a result of the recognition processing with respect to the image data 110 after the application of the noise shows that all of the recognition accuracy (ACCURACY), the total (TOTAL), and the accuracy rate (DETECTION) are decreased in value as compared to the case where the noise (e=4) is applied.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing method for a neural network model optimized by a training by using a processor and a memory for use in computation of the processor, the method comprising:
outputting a first information processing result by the neural network model using first input data;
outputting a second information processing result by the neural network model using second input data obtained by applying a perturbation to the first input data; and
determining a reliability of the neural network model using the first input data based on a comparison result between the first information processing result and the second information processing result.

2. The method of claim 1, wherein the neural network model is optimized by a training against adversarial examples used as the perturbation.

3. The method of claim 1, further comprising:
calculating a value indicative of a predetermined perturbation based on the first information processing result; and
outputting the second input data by applying the calculated value indicative of the predetermined perturbation to the first input data.

4. The method of claim 3, wherein the value indicative of the predetermined perturbation makes a loss included in the first information processing result relatively small.

5. The method of claim 1, wherein the perturbation includes adversarial examples.

6. The method of claim 5, wherein the determining comprises: determining that the neural network model has a low reliability with respect to the adversarial examples, if the comparison result shows that the first information processing result and the second information processing result are different from each other.

7. The method of claim 1, wherein the determining comprises: determining that the neural network model outputs a correct information processing result, if the comparison result shows that the first information processing result and the second information processing result are the same.

8. The method of claim 1, wherein the determining comprises: determining that an event of misrecognition due to an effect of the perturbation has occurred in the neural network model, if the comparison result shows that the first information processing result and the second information processing result are different from each other.

9. The method of claim 1, wherein the neural network model includes a convolutional neural network;
each of the first input data and the second input data includes image data; and
each of the first information processing result and the second information processing result includes an image recognition result.

10. An information processing apparatus for a neural network model optimized by a training, the apparatus comprising:
a processor; and
a memory configured to be used in processing of computation of the processor,
wherein the processor is configured to:
output a first information processing result by the neural network model using first input data;
output a second information processing result by the neural network model using second input data obtained by applying a perturbation to the first input data; and
determine a reliability of the neural network model using the first input data based on a comparison result between the first information processing result and the second information processing result.

11. The apparatus of claim 10, wherein the neural network model is optimized by a training against adversarial examples used as the perturbation.

12. The apparatus of claim 10, wherein the processor is configured to:
calculate a value indicative of a predetermined perturbation based on the first information processing result; and
output the second input data by applying the calculated value indicative of the predetermined perturbation to the first input data.

13. The apparatus of claim 10, wherein the processor is configured to determine that the neural network model outputs a correct information processing result, if the comparison result shows that the first information processing result and the second information processing result are the same.

14. The apparatus of claim 10, wherein the processor is configured to determine that an event of misrecognition due to an effect of the perturbation has occurred in the neural network model, if the comparison result shows that the first information processing result and the second information processing result are different from each other.

15. The apparatus of claim 10, wherein the processor is configured to determine that the neural network model has a low reliability with respect to adversarial examples, if the comparison result shows that the first information processing result and the second information processing result are different from each other.

16. The apparatus of claim 10, wherein the neural network model includes a convolutional neural network;
each of the first input data and the second input data includes image data; and
each of the first information processing result and the second information processing result includes an image recognition result.
